(19) United States
(12) Patent Application Publication
(10) Pub. No.: US 2016/0316610 A1
(43) Pub. Date: Nov. 3, 2016

(54) AUTOMATED SPRING FORCE ADJUSTMENT ASSEMBLY FOR SEED PLANTER

(71) Applicant: STEERING SOLUTIONS IP HOLDING CORPORATION, Saginaw, MI (US)

(72) Inventors: Matt R. Burk, Bay City, MI (US); Nicholas R. Alpers, Saginaw, MI (US); David L. Westphal, Midland, MI (US)

(21) Appl. No.: 15/142,630

(22) Filed: Apr. 29, 2016

Related U.S. Application Data
(60) Provisional application No. 62/155,060, filed on Apr. 30, 2015.

(51) Int. Cl. A01B 61/04; F16F 1/12; A01B 63/00; A01C 5/06

(52) U.S. Cl. CPC A01B 61/046; A01C 5/062; F16F 1/121; A01B 63/008

(57) ABSTRACT

An automated spring force adjustment assembly for a seed planter includes a screw. Also included is a spring wound around an outer surface of the screw. Further included is a nut in threaded engagement with the outer surface of the screw and in contact with the spring. Yet further included is a motor operatively coupled to the screw to rotatably drive the screw, rotation of the screw translating the nut, translation of the screw adjusting the compression of the spring.

### CROSS REFERENCE TO RELATED APPLICATION

This patent application claims priority to U.S. Provisional Patent Application Ser. No. 62/155,060, filed Apr. 30, 2015, which is incorporated herein by reference in its entirety.

### BACKGROUND OF THE INVENTION

The embodiments described herein relate to a seed planter and, more particularly, to an automated spring force adjuster for such seed planters.

Conventional planting implements currently used in farming, commonly referred to as “planters,” utilize a seed channel opener, typically in the form of a disc, that creates a channel or furrow in the soil for seed placement. Due to varying soil conditions of a field being planted, as well as different depths for different types of seeds being planted, it is desirable to adjust a spring force that assists in controlling the seed planting depth achieved during a planting operation.

Adjustment of the spring force requires manual adjustment by an operator. For example, an operator must exit a tractor to go to each individual planter row unit to manually turn a large retaining nut that is operatively coupled to the spring shaft to set an estimated down force pressure for the row unit. This adjustment system undesirably leads to costly wasted time by the operator. Furthermore, the adjustment of the spring force is subject to operator error, particularly as the operator becomes fatigued throughout the planting operation.

### SUMMARY OF THE INVENTION

According to one aspect of the disclosure, an automated spring force adjustment assembly for a seed planter includes a screw. Also included is a spring wound around an outer surface of the screw. Further included is a nut in threaded engagement with the outer surface of the screw and in contact with the spring. Yet further included is a motor operatively coupled to the screw to rotatably drive the screw, rotation of the screw translating the nut, translation of the screw adjusting the compression of the spring.

According to another aspect of the disclosure, an automated spring force adjustment system for a seed planter includes a controller unit. Also included is an electric motor in operative communication with the controller unit to receive a signal therefrom. Further included is a gear arrangement operatively coupled to an output shaft of the electric motor. Yet further included is a ball screw operatively coupled to the gear arrangement. Also included is a spring wound around the ball screw, the spring force controlling a seed planting depth. Further included is a ball nut in threaded engagement with the outer surface of the ball screw and in contact with the spring.

These and other advantages and features will become more apparent from the following description taken in conjunction with the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a plan view of a tractor towing a planter;

FIG. 2 is a perspective view of an automated spring force adjuster for a seed planter; and

FIG. 3 is a perspective view of the automated spring force adjuster with a housing removed.

### DETAILED DESCRIPTION

Referring now to the Figures, where the invention will be described with reference to specific embodiments, without limiting same, an automated spring force adjuster is provided to assist in seed planting operations.

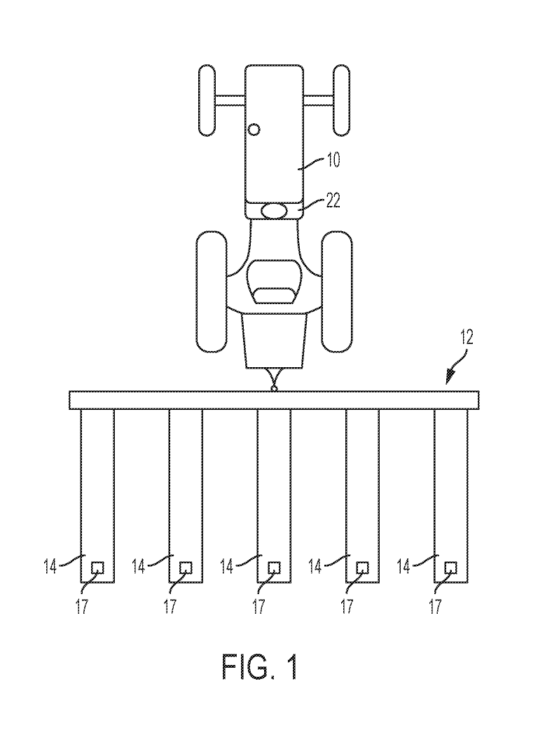

Referring to FIG. 1, schematically illustrated is tractor 10 with a planter 12 hitched thereto. Although not illustrated in detail, the planter 12 comprises a fixed main frame having tires attached thereto for movement along the ground. The planter 12 includes a disc assembly that is used to cut a channel for a seed to be placed. The disc assembly is operatively coupled to a gauge wheel that is used to set ground penetration depth during a seed planting operation. The gauge wheel is provided to follow behind the channel and pack the soil to a desired depth. The gauge wheel is mounted to a beam arrangement.

As shown, the planter 12 includes a plurality of row units 14 that are spaced from each other in a lateral direction. Each of the row units 14 translates over the ground and plants seeds at spaced intervals, and to a desired depth, along the direction of travel of the respective row unit. The desired depth is predetermined by an operator. The beam arrangement is mounted to facilitate seed planting depth control.

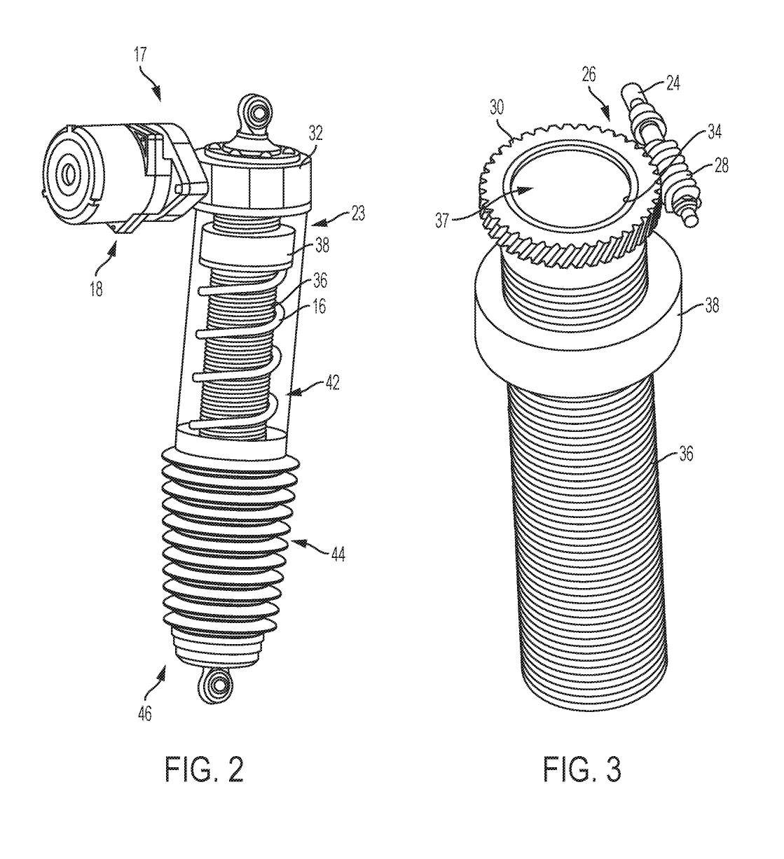

A biasing spring 16 (FIG. 2) is operatively coupled to the beam arrangement and is adjustable to adjust the force exerted by the spring 16, thereby controlling the beam arrangement, which assists in controlling the seed depth placement, as described above.

Rather than requiring manual adjustment of the spring force, the embodiments described herein provide an operator the advantages of an automated spring force adjustment system 17. The automated system includes an electric motor 18 (FIGS. 2 and 3) that is position controlled by a controller based on a signal sent from a controller unit 22. In some embodiments the signal sent to the electric motor controller is sent in a wired manner and in alternative embodiments the signal is sent wirelessly. In one embodiment, the controller unit 22 is located onboard the tractor 10 and includes a monitor that the operator may interact with. Such an embodiment may include a touch screen that allows the operator to input commands with. Alternatively, the controller unit 22 may be operated by a wireless device, such as a tablet, laptop computer, cellular phone or the like. Regardless of the specific type of controller unit interface employed, the operator may adjust all of the spring forces of biasing spring 16 (FIG. 2) for each respective individual row unit 14 at the same time and consistently. Each row unit 14 will have the same loads exerted based on the similar signal being sent to each unit. Alternatively, different rows may be adjusted with a different spring force than adjacent rows.

Referring to FIGS. 2 and 3, the automated spring force adjustment system 17 is illustrated in greater detail. FIG. 2 illustrates the automated spring force adjustment system 17 with a housing assembly 23, while the housing assembly 23 is removed in FIG. 3 to better illustrate certain features of the system 17. The electric motor 18 is illustrated and includes an output shaft 24. The particular type of electric motor employed may vary depending upon the particular application, but in some embodiments, the electric motor 18 is a 3-phase, 12 Volt DC motor. Irrespective of the type of motor, the output shaft 24 is operatively coupled to a worm gear arrangement 26 that is non-back drivable to drive the worm gear arrangement 26. More particularly, the output shaft 24 is operatively coupled to a worm 28 of the arrangement 26, which rotates a worm wheel 30 that the worm 28 is engaged with. The gear ratio of the worm gear arrangement 28 may vary depending upon the particular application, but in some embodiments a 15:1 worm gear box is employed. As shown in FIG. 2, the housing assembly 23 includes a gearbox housing 32 that environmentally seals the worm gear arrangement 26 to maintain operational integrity of the worm gear arrangement 26.

The worm wheel 30 is operatively coupled to, or integrally formed with, a screw (shown as a ball screw 34). The ball screw 34 is a hollow screw having a hollowed portion 37 that is fitted over an existing shock for dampening of the overall system in some embodiments. The biasing spring 16 is disposed about, and in contact with, an outer surface 36 of the ball screw 34. As discussed above, adjustment (e.g., compression) of the biasing spring 16 adjusts the planting depth of seeds or the like. Adjustment of the biasing spring 16 is achieved by interaction of a nut (shown as a ball nut 38) with the biasing spring 16. The ball nut 38 is in threaded engagement with the outer surface 36 of the ball screw 34.

In operation, an operator provides an input with the controller unit 22 (FIG. 1) to send a signal to the electric motor 18, which drives the worm gear arrangement 26 to rotate the ball screw 34. Rotation of the ball screw 34 results in linear movement of the ball nut 38 in a longitudinal direction 40 of the ball screw 34. The linear movement of the ball nut 38 compresses or relaxes the biasing spring 16 to a desired compression, which controls the planting depth.

As shown in FIG. 2, the housing assembly 23 also includes a screw housing 42 to environmentally seal the ball screw 34, ball nut 38 and biasing spring 16. The screw housing 42 maintains operational integrity of the sealed components. In some embodiments, the screw housing 42 and the gearbox housing 32 are separate components. Alternatively, the screw housing 42 and the gearbox housing 32 are integrally formed to define a single, unitary housing assembly 23.

A corrugated boot 44 surrounds a portion of the ball screw 34 to allow movement of the automated spring force adjustment system 17 in a flexible manner. Based on the environmentally sealed system, a breathing feature 46 is provided proximate an end of the corrugated boot 44 to provide air exchange. This relieves pressure within the sealed regions

Advantageously, the automated spring force adjustment system reduces operator time by completely eliminating manual adjustment time required by other planter systems. Furthermore, the opportunity for operator error generally, and particularly between row units, is greatly reduced.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

Having thus described the invention, it is claimed:

1. An automated spring force adjustment assembly for a seed planter comprising:
a screw;
a spring wound around an outer surface of the screw;
a nut in threaded engagement with the outer surface of the screw and in contact with the spring; and
a motor operatively coupled to the screw to rotatably drive the screw, rotation of the screw translating the nut, translation of the screw adjusting the compression of the spring.

2. The automated spring force adjustment assembly of claim 1, further comprising a gear arrangement operatively coupling the motor to the screw.

3. The automated spring force adjustment assembly of claim 2, wherein the gear arrangement comprises a worm operatively coupled to an output shaft of the motor and a worm wheel, the worm wheel operatively coupled to the screw.

4. The automated spring force adjustment assembly of claim 2, further comprising a housing assembly environmentally sealing a portion of the automated spring force adjustment assembly.

5. The automated spring force adjustment assembly of claim 4, wherein the housing assembly includes a gearbox housing that environmentally seals the gear arrangement.

6. The automated spring force adjustment assembly of claim 4, wherein the housing assembly includes a screw housing that environmentally seals the screw, the nut and the spring.

7. The automated spring force adjustment assembly of claim 1, wherein the motor is a 3-phase, 12 Volt DC motor.

8. The automated spring force adjustment assembly of claim 1, further comprising a corrugated boot surrounding a portion of the screw.

9. The automated spring force adjustment assembly of claim 4, further comprising an air exchanging component operatively coupled to the housing assembly to ventilate an interior of the housing assembly.

10. The automated spring force adjustment assembly of claim 9, wherein the air exchanging component comprises a breathable fabric membrane.

11. The automated spring force adjustment assembly of claim 1, wherein the screw is a ball screw and the nut is a ball nut.

12. An automated spring force adjustment system for a seed planter comprising:
a controller unit;
an electric motor in operative communication with the controller unit to receive a signal therefrom;
a gear arrangement operatively coupled to an output shaft of the electric motor;
a ball screw operatively coupled to the gear arrangement;
a spring wound around the ball screw, the spring force controlling a seed planting depth; and
a ball nut in threaded engagement with the outer surface of the ball screw and in contact with the spring.

13. The automated spring force adjustment system of claim 12, wherein the controller unit is fixed at an onboard location of a tractor configured to tow the seed planter.

14. The automated spring force adjustment system of claim 12, wherein the controller unit is a portable device.

15. The automated spring force adjustment system of claim 12, wherein the gear arrangement comprises a worm operatively coupled to the output shaft of the motor and a worm wheel, the worm wheel operatively coupled to the ball screw.

16. The automated spring force adjustment system of claim 12, further comprising a housing assembly environmentally sealing a portion of the automated spring force adjustment system, and the housing assembly includes a gearbox housing that environmentally seals the gear arrangement.

17. The automated spring force adjustment system of claim 16, wherein the housing assembly includes a screw housing that environmentally seals the ball screw, the ball nut and the spring.

18. The automated spring force adjustment system of claim 12, wherein the electric motor is a 3-phase, 12 Volt DC motor.

19. The automated spring force adjustment system of claim 12, further comprising a corrugated boot surrounding a portion of the ball screw.

20. The automated spring force adjustment system of claim 12, further comprising an air exchanging component operatively coupled to the housing assembly to ventilate an interior of the housing assembly, the air exchanging component comprising a breathable fabric membrane.
